(19) United States
(12) Patent Application Publication
(10) Pub. No.: US 2006/0258377 A1
(43) Pub. Date: Nov. 16, 2006

(54) Method and sysem for customizing vehicle services

(75) Inventors: George A. Economos, Sterling Heights, MI (US); Michael G. Zambo, Warren, MI (US); Christopher L. Oesterling, Troy, MI (US); Steven J. Ross, Livonia, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/126,596

(22) Filed: May 11, 2005

(51) Int. Cl. H04Q 7/20

(52) U.S. Cl. 455/461

(57) ABSTRACT

A method of customizing vehicle services includes receiving at least one telecommunication profile parameter at a telematics unit and indexing the received telecommunication profile parameters to a user identification. A user identification signal is received, and at least one vehicle service is customized based on the telecommunication profile parameters corresponding to the user identification signal.

### FIELD OF THE INVENTION

The present invention generally relates to customizing vehicle services.

### BACKGROUND OF THE INVENTION

Many modern vehicles offer customization services in response to the driver. Often, these services allow for a single vehicle that is driven by multiple drivers (e.g., husband and wife) to have a vehicle profile for each driver, such that the vehicle automatically adopts a particular profile when the particular driver enters the vehicle, or turns on the ignition.

For example, if one driver is taller than the other, the vehicle profile stores seat position information, and automatically places the driver seat in the preferred position for the current driver.

However, inclusion of telematics services increases the complexity of profiles, and prior art systems fail to account for telematics preferences.

The present invention overcomes these disadvantages and advances the state of the art.

### SUMMARY OF THE INVENTION

One aspect of the present invention provides a method of customizing vehicle services. The method includes receiving at least one telecommunication profile parameter at a telematics unit and indexing the received telecommunication profile parameters to a user identification. A user identification signal is received, and at least one vehicle service is customized based on the telecommunication profile parameters corresponding to the user identification signal.

One aspect of the present invention provides a computer usable medium including computer readable code for customizing vehicle services. The medium includes computer readable code for receiving at least one telecommunication profile parameter at a telematics unit and computer readable code for indexing the received telecommunication profile parameters to a user identification. The medium further includes computer readable code for receiving a user identification signal, and computer readable code for customizing at least one vehicle service based on the telecommunication profile parameters corresponding to the user identification signal.

Another aspect of the present invention provides a system for customizing vehicle services. The system includes means for receiving at least one telecommunication profile parameter at a telematics unit and means for indexing the received telecommunication profile parameters to a user identification. Means for receiving a user identification signal are included in the system as well as means for customizing at least one vehicle service based on the telecommunication profile parameters corresponding to the user identification signal.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

FIG. 1 illustrates an operating environment for a method for customizing vehicle services;

FIG. 2 illustrates one embodiment of a method for customizing vehicle services in accordance with one aspect of the invention;

FIG. 3 illustrates another embodiment of a method for customizing vehicle services in accordance with one aspect of the invention;

FIG. 4 illustrates one embodiment of a method for determining a new user identification in accordance with one aspect of the invention;

FIG. 5 illustrates one embodiment of a method for initiating a connection with a profile storage device in accordance with one aspect of the invention;

FIG. 6 illustrates one embodiment of a telecommunications profile in accordance with one aspect of the invention;

FIG. 7 illustrates another embodiment of a method for customizing vehicle services in accordance with one aspect of the invention;

FIG. 8 illustrates one embodiment of a method for getting a personalization message set in accordance with one aspect of the invention;

FIG. 9 illustrates one embodiment of a method for customizing vehicle services in accordance with one aspect of the invention;

FIG. 10 illustrates one embodiment of a method for determining personalization status in accordance with one aspect of the invention;

FIG. 11 illustrates one embodiment of a method for reporting personalization status in accordance with one aspect of the invention; and

FIG. 12 illustrates one embodiment of a method for personalization message set post-processing in accordance with one aspect of the invention.

### DETAILED DESCRIPTION OF THE PREFERRED EMBODIMENTS

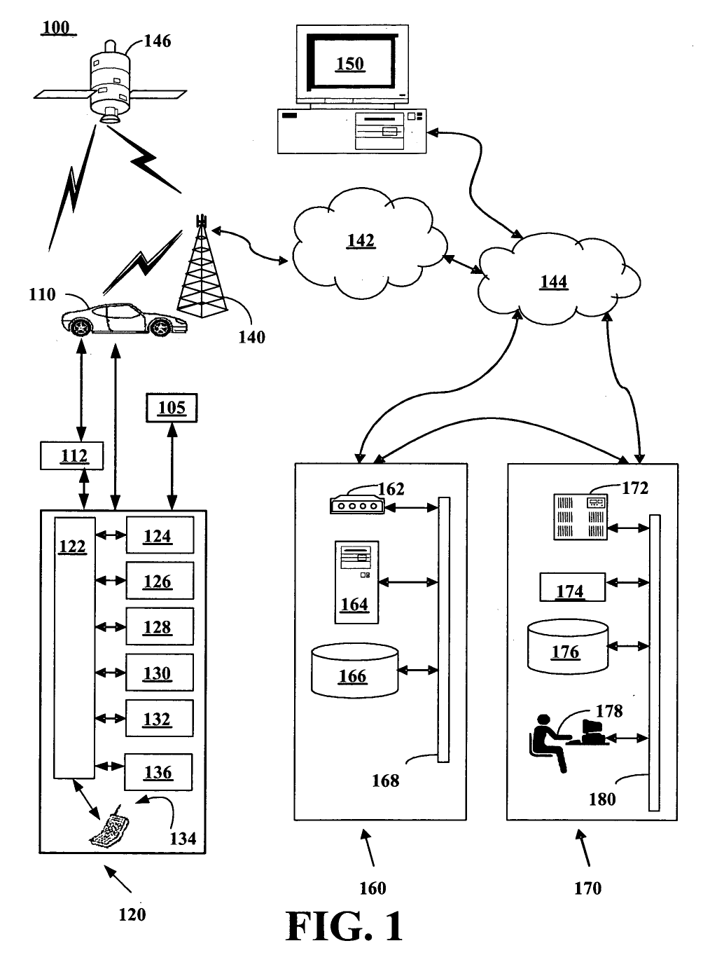

FIG. 1 illustrates an operating environment for a mobile vehicle communication system (“MVCS”) 100 for customizing vehicle services. MVCS 100 includes a mobile vehicle communication unit (“MVCU”) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, marine vehicle or as an aircraft. MVCU 110 may include additional components not relevant to the present discussion.

Vehicle communication network 112 sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Telematics unit 120 sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (“GPS”) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. In one embodiment, telematics unit 120 includes a battery power monitor 136 operably connected to a vehicle battery and configured to estimate a battery power level. Telematics unit 120 may include additional components not relevant to the present discussion. Telematics unit 120 is one example of a vehicle module.

In one embodiment, telematics unit 120 is configured to receive a user identification signal and retrieve an indexed telecommunication profile associated with the received user identification signal. Telematics unit 120 may retrieve the indexed telecommunication profile from any memory device in communication with telematics unit 120. In one embodiment, the memory device is located within telematics unit 120, or within MVCU 110. In another embodiment, the memory device is located at call center 170 (described in further detail below) or in a location outside MVCU 110.

In one embodiment, processor 122 is implemented as a microcontroller, controller, host processor, or vehicle communications processor. In one embodiment, processor 122 is a digital signal processor. In an example, processor 122 is implemented as an application specific integrated circuit. In another embodiment, processor 122 is implemented as a processor working in conjunction with a central processing unit performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode, or multi-band cellular phone.

Processor 122 executes various computer programs that control programming and operational modes of electronic and mechanical systems within MVCU 110. Processor 122 controls communication (e.g., call signals) between telematics unit 120, wireless carrier system 140, and call center 170. Additionally, processor 122 controls reception of communications from satellite broadcast system 146. In one embodiment, a voice-recognition application is installed in processor 122 that can translate human voice input through microphone 130 to digital signals. Processor 122 generates and accepts digital signals transmitted between telematics unit 120 and vehicle communication network 112 that is connected to various electronic modules in the vehicle. In one embodiment, these digital signals activate the programming mode and operation modes, as well as provide data transfers such as, for example, data over voice channel communication. In this embodiment, signals from processor 122 are translated into voice messages and sent out through speaker 132.

Profile storage device 105 is in electronic communication with telematics unit 120. Profile storage device 105 is any electronic device configured to store data, and communicate the stored data with the telematics unit. In one embodiment, profile storage device is a device held by a user, such as a key fob, laptop computer, personal digital assistant, cellular telephone, MP3 player, and device containing a RFID tag, such as a smart card. In another embodiment, the personal storage device 105 is another vehicle in communication with the telematics unit, for example via an ad hoc peer to peer network. In another embodiment, the profile storage device is a storage device held at a call center, such as call center 170, described in greater detail below. In one embodiment, profile storage device 105 also identifies the holder of the profile storage device 105. In one embodiment, profile storage device 105 is configured to transmit a wireless user identification signal for reception by telematics unit 120. In embodiments utilizing a profile storage device that is not configured to transmit a user identification signal, a second device to transmit a user identification signal is required.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band of 2.3 GHz that has been allocated by the U.S. Federal Communications Commission for nationwide broadcasting of satellite-based Digital Audio Radio Service.

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. In an example, processor 122 implements data packets received by telematics unit 120.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network. In another embodiment, land network 144 is implemented as an Internet Protocol (“IP”) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browsers and Internet-access computer programs for sending and receiving data over land network 144 and, optionally, wired or wireless communication networks 142 to web-hosting portal 160 through a web-page interface using communication standards such as hypertext transport protocol, and transport-control protocol and Internet protocol. In one embodiment, the data include directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data are stored at web-hosting portal 160.

Web-hosting portal 160 includes one or more data modems 162, one or more web-servers 164, one or more databases 166, and a network system 168. Web-hosting portal 160 is connected directly by wire to call center 170, or connected by phone lines to land network 144, which is connected to call center 170. In an example, web-hosting portal 160 connects to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that are then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web server 164 hosting portal 160 through a wireless communication network 142 and a land network 144. Data are received by land network 144 and sent to one or more web servers 164. In one embodiment, web server 164 is implemented as any suitable hardware and software capable of providing web server 164 services to help change and transmit personal preference settings from a client at computer 150 to telematics unit 120. Web server 164 sends to or receives from one or more databases 166 data transmissions via network system 168. Web server 164 includes computer applications and files for managing and storing personalized settings supplied by the client, such as door lock/unlock behavior, radio station preset selections, climate controls, custom button configurations, and theft alarm settings. For each client, the web server 164 potentially stores hundreds of preferences for wireless vehicle communication, networking, maintenance and diagnostic services for a mobile vehicle. In another embodiment, web server 164 further includes data for managing turn-by-turn navigational instructions.

In one embodiment, one or more web servers 164 are networked via network system 168 to distribute user-preference data among its network components such as databases 166. In an example, database 166 is a part of or a separate computer from web server 164. Web server 164 sends data transmission with user preferences to call center 170 through land network 144.

Call center 170 is a location where many calls are received and serviced at the same time, or where many calls are sent at the same time. In one embodiment, the call center is a telematics call center facilitating communications to and from telematics unit 120. In another embodiment, the call center is a voice call center, providing verbal communications between an advisor in the call center and a subscriber in a mobile vehicle. In yet another embodiment, the call center contains each of these functions. In other embodiments, call center 170 and web server 164 and hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web server 164 and hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmission via network system 180. In one embodiment, communication services manager 174 includes at least one digital and/or analog modem.

Communication services manager 174 sends to or receives from one or more communication services advisors 178 data transmission via network system 180. Communication services database 176 sends or receives from communication services advisor 178 data transmissions via network system 180. Communication services advisor 178 receives from or sends to switch 172 voice or data transmissions. Communication services manager 174 provides one or more of a variety of services including initiating data over voice channel wireless communication, enrollment services, navigation assistance, directory assistance, roadside assistance, business or residential assistance, information services assistance, emergency assistance, and communications assistance.

Communication services manager 174 receives service-preference requests for a variety of services from the client computer 150, web server 164, hosting portal 160, and land network 144. Communication services manager 174 transmits user-preference and other data such as, for example, primary diagnostic script to telematics unit 120 through wireless carrier system 140, communication network 142, land network 144, voice and data switch 172, and network system 180. Communication services manager 174 stores or retrieves data and information from communication services database 176. Communication services manager 174 may provide requested information to communication services advisor 178. In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to a telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140, and satellite broadcast system 146. In this embodiment, an inbound communication is routed to call center 170 from telematics unit 120 via wireless carrier system 140, communication network 142, and land network 144.

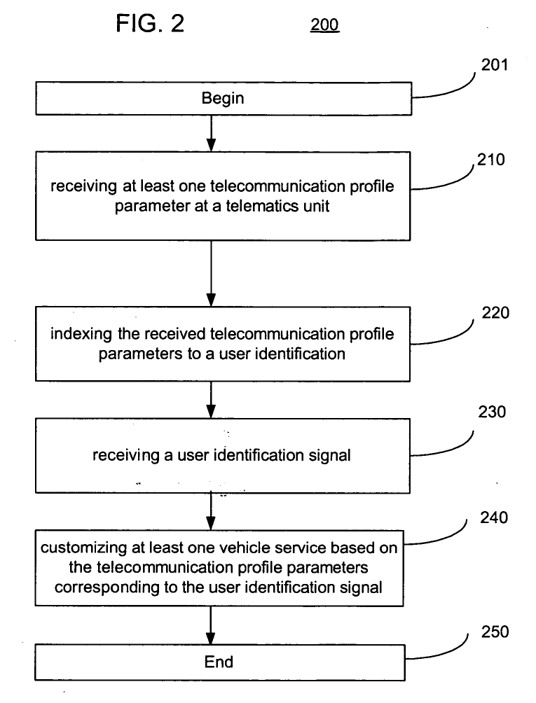

FIG. 2 illustrates one embodiment of a method 200 for customizing vehicle services in accordance with one aspect of the invention. Method 200 begins at step 201.

Telematics unit 120 receives at least one telecommunication profile parameter at step 210. A telecommunication profile parameter is information reflecting a personal preference for delivery of a specified service. Numerous types of information are contemplated, including phone numbers, points of interest, radio presets, navigational information, hotel preferences, restaurant preferences, website location (e.g. Uniform Resource Locator) information, email address, text messaging addresses, voice recognition information, identification information linked to at least one address, wake up cycle information, menu item preferences, reminder prompts, security mode, speech recognition learned profiles, speech recognition adapted acoustic models, and personal reminders. Reminder prompts and personal reminders include, but are not limited to, birthday and anniversary reminders, as well as other calendar functions. Other information that can be stored as a profile parameter includes twilight delay, auto exit seat, steering wheel control keys, speed controlled volume, oil life, radio presets, radio theft reset, stealth mode for law enforcement fleets, and HVAC after blow settings.

A wake up mode, as used herein, is a mode during which a telematics unit is not in a fully energized state, but during which the telematics unit is configured to send and/or receive communications to or from the wireless network 140. Additionally, while the telematics unit in a wake up mode, the telematics unit is configured to send and receive communications to and from the vehicle network 112, in one embodiment.

For example, establishing a telecommunication profile allows multiple persons to have the name tag “mom” in the same vehicle, and each nametag “mom” be associated with the correct person.

Receiving at least one telecommunication profile parameter generates a telecommunication profile, in one embodiment. The telecommunication profile is, in one embodiment, stored in a table. An exemplary telecommunication profile table 600 is illustrated in FIG. 6. As illustrated, the telecommunication profile comprises a plurality of information bits, shown as Iₘₙ.

A telecommunication profile may be applicable to a single driver, a plurality of drivers or all drivers. The telecommunication profile may be entirely private and limited to a single driver or group of drivers, or at least a portion of the telecommunication profile may be shared among at least two drivers. In one embodiment, a generic telecommunication profile, known as an “Any Driver” profile, applies to default driver preferences, and is included in the telecommunication profile.

The received telecommunication profile is indexed to a user identification at step 220. A user identification is information associating a telecommunication profile to at least one human user of the telematics unit 120. Indexing the received telecommunication profile to a user identification results in linking the telecommunication profile and user identification such that the telecommunication profile and user identification are associated.

A user identification signal is received at step 230. A key fob, in one embodiment, transmits the user identification signal. In another embodiment, a profile storage device, such as profile storage device 105, transmits the user identification signal. In another embodiment, the user identification signal results from a button push. In yet another embodiment, the user identification signal is an oral command enunciated from within the cabin of MVCU 110.

At least one vehicle service is customized based on the telecommunication profile parameters corresponding to the user identification signal at step 240. For example, a phone list comprising frequently dialed numbers is customized based on the person currently operating MVCU 110. Method 200 ends at step 250.

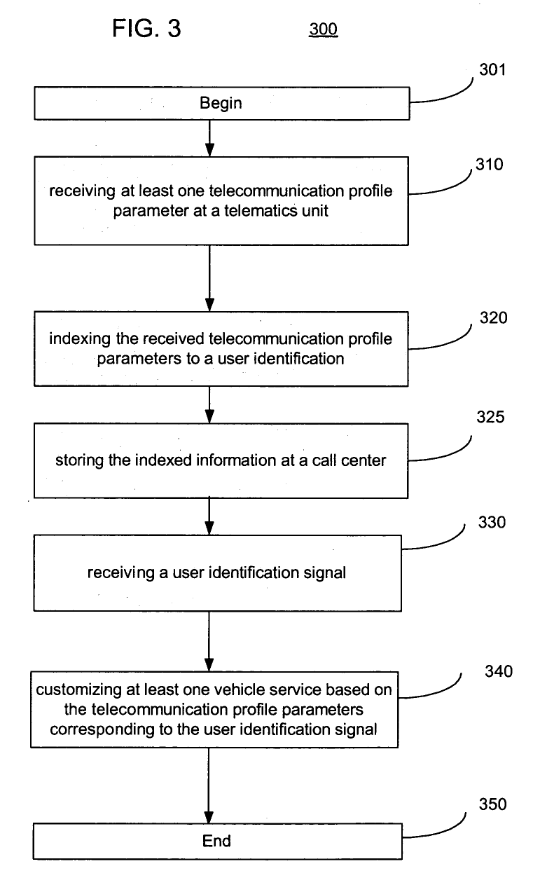

FIG. 3 illustrates another embodiment of a method 300 for customizing vehicle services in accordance with one aspect of the invention. Method 300 begins at step 301.

Telematics unit 120 receives at least one telecommunication profile parameter at step 310. In one embodiment, step 310 is implemented as step 210.

The received telecommunication profile is indexed to a user identification at step 320. In one embodiment, step 320 is implemented as step 220.

The indexed telecommunications profile is stored at a call center at step 325. Storing the telecommunications profile at the call center, in one embodiment, comprises transmitting the telecommunications profile to the call center via a wireless connection. In another embodiment, the telecommunications profile is transmitted to the call center via a packet data network, such as a network operating using an Internet Protocol. In one embodiment, a web interface is operated to receive and transmit the telecommunications profile. In one embodiment, the call center is implemented as call center 170. The telecommunications profile is stored using any appropriate storage scheme.

In one embodiment, a driver who owns a vehicle within MVCS 100 and then rents another vehicle within MVCS 100 may have their telecommunications profile stored at the call center, and then transferred to the rental vehicle. Alternatively, a driver who owns a vehicle within MVCS 100 and has vehicle repairs resulting in a disconnected battery may have their telecommunications profile stored at the call center and then transferred back to the vehicle after the battery is reconnected. In another embodiment, a driver, such as a truck driver or taxi driver, who operates several vehicles 110 within the MVCS 100 has their telecommunications profile follow the driver to each vehicle 110 that they operate.

A user identification signal is received at step 330. In one embodiment, step 330 is implemented as step 230.

At least one vehicle service is customized based on the telecommunication profile parameters corresponding to the user identification signal at step 240. In one embodiment, step 340 is implemented as step 240. Method 300 ends at step 350.

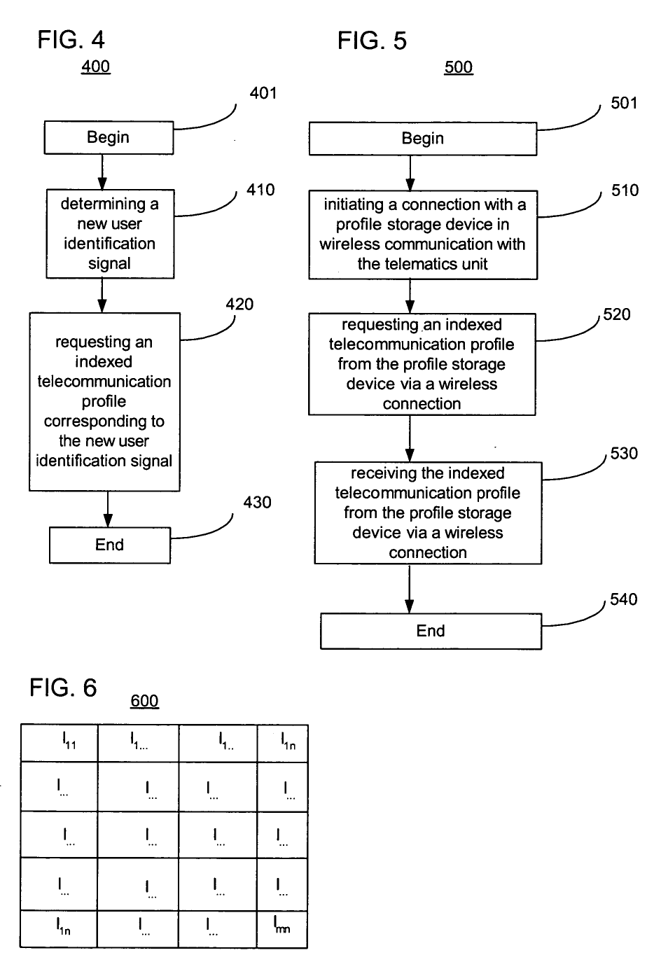

FIG. 4 illustrates one embodiment of a method 400 for receiving a user identification signal, in accordance with one aspect of the invention. Method 400 begins at step 401. Method 400 is especially applicable for embodiments of the invention wherein the telecommunication profile is stored in a profile storage device within or near the telematics unit 120.

At step 410, a new user identification signal is determined. A new user identification signal is a received user identification signal that does not match a user identification signal stored in a memory in communication with the telematics unit. For example, a new driver enters MVCU 110, so that the new driver's profile information is not stored in profile storage device 105.

In response to determining a new user identification signal, telematics unit 120 requests an indexed telecommunications profile corresponding to the new user identification, at step 420. Method 400 ends at step 430.

FIG. 5 illustrates one embodiment of a method 500 for requesting an indexed telecommunications profile corresponding to the new user identification, in accordance with one aspect of the invention. Method 500 begins at step 501.

Telematics unit 120 initiates a connection with a profile storage device in wireless communication with the telematics unit at step 510. In one embodiment, the profile storage device is implemented as profile storage device 150. In one embodiment, a connection is initiated by sending a ‘ping’ to determine the presence of a profile storage device. In one embodiment, the connection operates using a short range wireless protocol, such as a FCC Part 15 protocol, such as 802.11. In another embodiment, the connection is made using a RFID protocol. In another embodiment, the connection is attempted using a cellular network to contact the call center. In one embodiment, the telematics unit 120 first attempts to initiate a connection using a short-range wireless communications protocol, and only attempts a cellular connection on a failure to complete a connection using the short range protocol.

Telematics unit 120 requests an indexed telecommunications profile from the profile storage device 105 using the wireless connection at step 520. In one embodiment, the telecommunications profile is requested by sending the new user identification to the profile storage device.

The indexed telecommunications profile is received using the wireless connection at the telematics unit at step 530. Method 500 ends at 540.

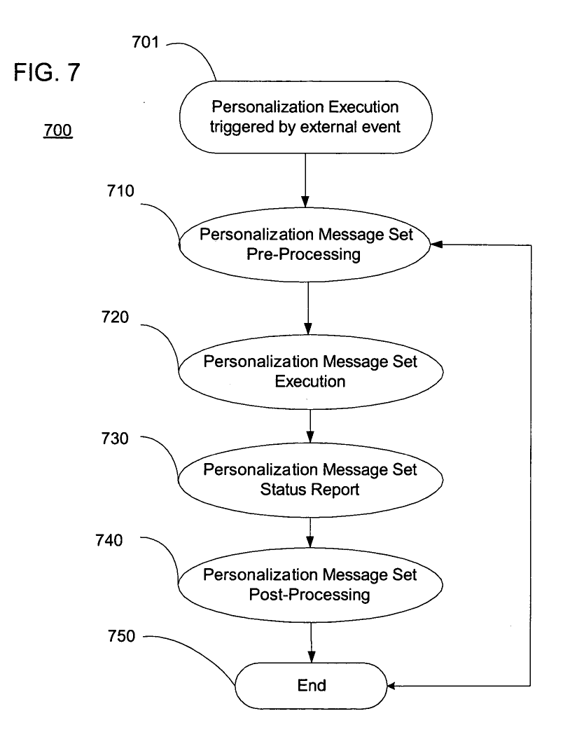

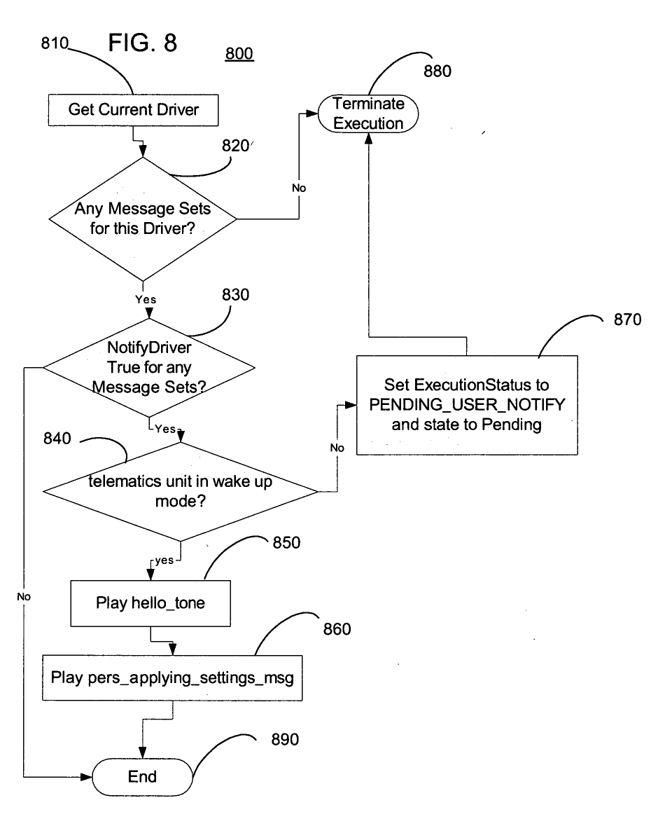

FIG. 7 illustrates one embodiment of a method for personalization execution in accordance with one aspect of the invention. Method 700 begins at step 701 when personalization execution is triggered by an external event. The external event can be a vehicle power on, detection of a driver change notification, transition to a safe mode or an available mode for a pending message. A driver change notification occurs when a driver change is detected. For example, a driver change may be detected in response to a button press, key fob usage, or easy key detection. Other methods to detect driver changes are known to those of skill in the art, and are contemplated within this disclosure.

A personalization message set message includes, in one embodiment, a unique identifier for the message set, an execution status indicative of the current status of the execution of the message set, a number of execution attempts to be made for the personalization message set and a status indicator for each personalization message in the personalization message set. In one embodiment, the personalization message status indicator includes a parameter identification, a network status execution status and whether the network responded after sending the personalization message. In another embodiment, the telematics unit includes response criteria parameters.

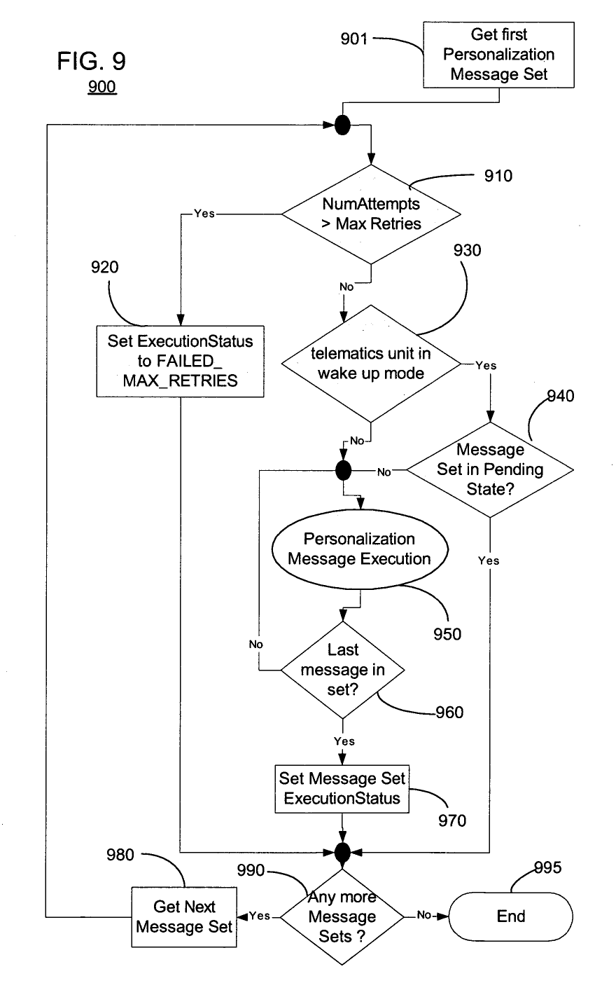

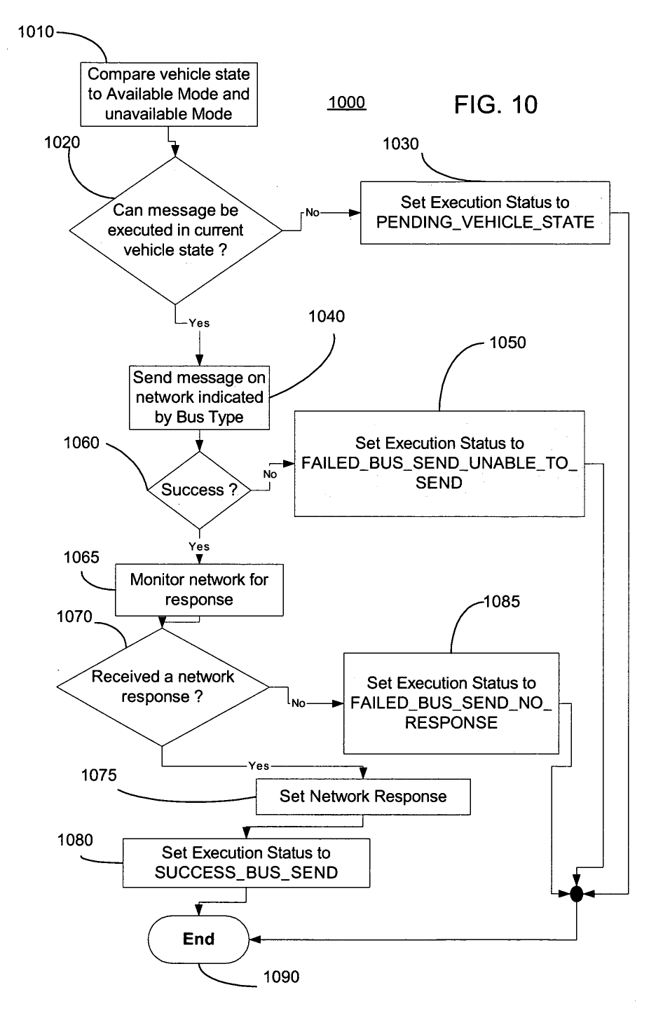

The personalization message is set for preprocessing at step 710. The personalization message set is executed at step 720. One embodiment of a method for preprocessing is described with reference to FIG. 8, below. A personalization message set status report is generated at step 730, and personalization set post-processing is completed at step 740. One embodiment of a method for generating a personalization message set status report and an embodiment of method for personalization set post-processing is described with reference to FIGS. 9 and 10, below. Method 700 ends at step 750.

In one embodiment, method 700 continues to execute after a vehicle ignition is turned off.

FIG. 8 illustrates one embodiment of personalization message set pre-processing method 800, in accordance with one aspect of the invention. In one embodiment, method 800 is executed during step 710. Method 800 begins at 810 by getting the current driver identification. The current driver identification is obtained by reading current driver information from, for example, the vehicle network 112 or, in another embodiment, by directly contacting profile storage device 105. In one embodiment, if no particular driver is identified, an “any” driver identification may be read to apply any global changes, such as in a vehicle not configured to determine a driver, or in the case of a global change. Once the current driver identification is received, the telematics unit determines whether any message sets for the current driver are available, at step 820. If no message sets are waiting for the current driver, method 800 terminates at step 880. If message sets are waiting for the driver, telematics unit 120 determines whether to notify the driver (NotifyDriver true?) for any message within the message set, at step 830. If telematics unit 120 is not in a sleep mode during its wake up cycle, determined at step 840, a hello tone (hello_tone), or other initial communication, is played to the user at step 850. In the event that the telematics unit is in a sleep mode, the execution status is set to pending_user_notify, and the state is set to pending, at step 870, prior to terminating method 800 at step 880. After the hello tone is played for the driver, a message indicating that the personalization is occurring (pers_applying_settings_msg) is played for the current driver at step 860.

FIG. 9 illustrates one embodiment of a method 900 for personalization message set execution, in accordance with one aspect of the invention. In one embodiment, method 900 is executed during step 720. In one embodiment, personalization message sets are executed in chronological order, as determined in any appropriate method, such as a GPS time, a time stamp, a message identifier or similar techniques. In other embodiments, a ‘priority’ stamp provides priority execution to personalization message sets such that a priority personalization message set is executed prior to a nonpriority personalization message set. In one embodiment, a priority stamp is applied to a personalization message set in the event that a prior attempt to execute the personalization message set fails.

Method 900 begins at step 901 by getting the first personalization message set. A personalization message set is a list of instructions to customize vehicle services based on a telecommunication profile.

At step 910, method 900 determines whether the number of attempts to execute the personalization message set is greater than a predetermined number of maximum retries. The predetermined number of maximum retries may be statically or dynamically set, and based on user or manufacturer preferences. If the number of attempts is greater than the maximum, the execution status is set to failed (failed_max_retries) at step 920, and method 900 proceeds to determine if any more personalization message sets are in queue at step 990. If the number of attempts is not greater than the maximum retries, method 900 determines if the telematics unit is in a wake up mode at step 930 and, if yes, determines whether the message set is in a pending state at step 940. If the message set is in a pending state at step 940, method 900 proceeds to determine if any more personalization message sets are in queue at step 990.

If the telematics unit is not in a wake up mode during step 930, or if the message set is not in a pending state during step 940, the personalization message set execution begins at step 950.

After executing each message in the personalization message set during step 950, method 900 determines whether the executed message was the last message in the personalization message set during step 960, and repeats step 950 until the last personalization message is executed. Upon executing the last message in the personalization message set, the message set execution status is set at step 970, prior to determining whether more personalization message sets are in queue at step 990.

If more personalization message sets are in queue at step 990, method 900 proceeds to get the next personalization message set at step 980, and returns to step 910. If no more personalization message sets are in queue at step 990, method 900 ends at step 995.

FIG. 10 illustrates one embodiment of a method 1000 for executing a personalization message set in accordance with one aspect of the invention. In one embodiment, method 1000 is executed during step 950.

Method 1000 begins at step 1010 by comparing the current vehicle state to an available mode and an unavailable mode. In one embodiment, the vehicle state is available when the vehicle is not moving, and is in a “neutral” or “park” transmission position. In one embodiment, the vehicle state is unavailable if the vehicle is moving or the transmission is in gear to allow movement of the vehicle. In another embodiment, vehicle state is determined based on a power mode, an ignition mode, and a transmission state.

At step 1020, method 1000 determines whether the instant personalization set message can be executed while the vehicle is in its current state. In one embodiment, no personalization set message can be executed while the vehicle is in an unavailable mode. In another embodiment, the ability to execute a particular personalization set message is evaluated individually to determine if the personalization set message can be executed even in an unavailable mode. For example, a personalization set message to update a phone book listing may be executable while the vehicle mode is unavailable, while a personalization set message to change a seat position may not be executable while the vehicle mode is unavailable.

If the message cannot be executed during the current vehicle state, the execution status of the message is set to pending (pending_vehicle_state) in step 1030, and flow proceeds to end at step 1090.

If the message can be executed during the current vehicle state, the message is sent to the hardware/software to be customized or configured over the vehicle network 112 as indicated by a bus indicator in the message, during step 1040.

After sending the message, method 1000 determines if the sending was successful at step 1060, and if not successful, sets the execution status to failed (failed_bus_send_unable_to_send) at step 1050, prior to ending at step 1090.

If the sending was successful, method 1000 monitors the network 112 for a response at step 1070, and if no response is received, sets the execution status to failed (failed_bus_send_no_response) prior to ending at step 1090. If the network response is received, the network response is set at step 1075, prior to setting the execution status to successful (success_bus_send) and ending at step 1090.

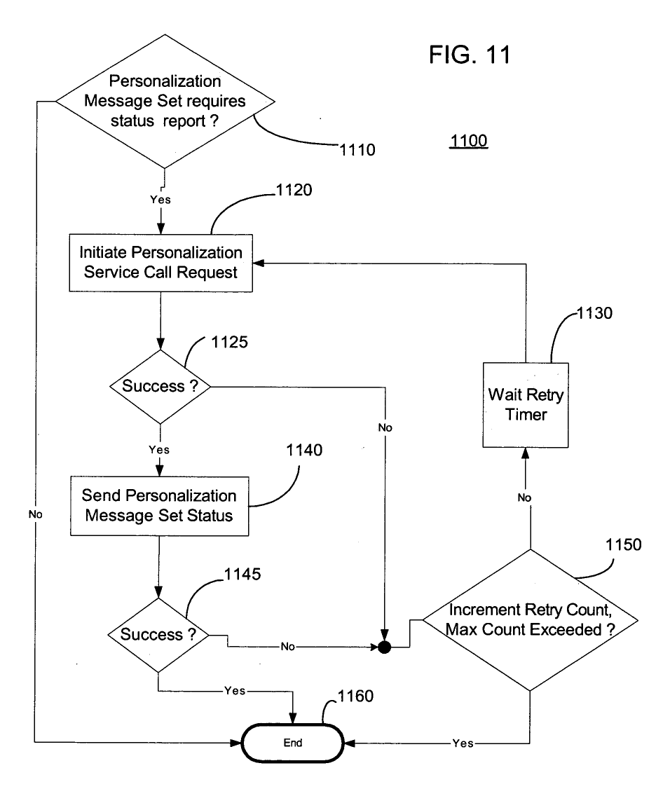

FIG. 11 illustrates one embodiment of a method 1100 for setting a personalization message status report, in accordance with one aspect of the invention. In one embodiment, method 1100 is performed during step 730.

Method 1100 begins at step 1110 by determining whether the personalization message set being processed requires a status report. If so, method 1100 initiates a personalization service call request, and if not, method 1100 ends at step 1160.

In response to initiating a personalization service call request, method 1100 determines whether the initiation was successful at step 1125, and if successful sets the personalization message set status at step 1140. If the initiation was unsuccessful, method 1100 increments the retry count and determines if the max recount has been exceeded at step 1150. If the max count has been exceeded, method 1100 ends at step 1160, while if the max count has not been exceeded, method 1100 returns to attempt another initiation of the personalization service call request in step 1120, after waiting a retry wait time at step 1130. The retry wait time may be configured by a user or a manufacturer, and may be dynamically or statically determined.

If the initiation was successful during step 1125, the personalization message set status is sent at step 1140, and if successful (step 1145), method 1100 ends at step 1160, while if the sending is not successful, method 1100 returns to step 1125.

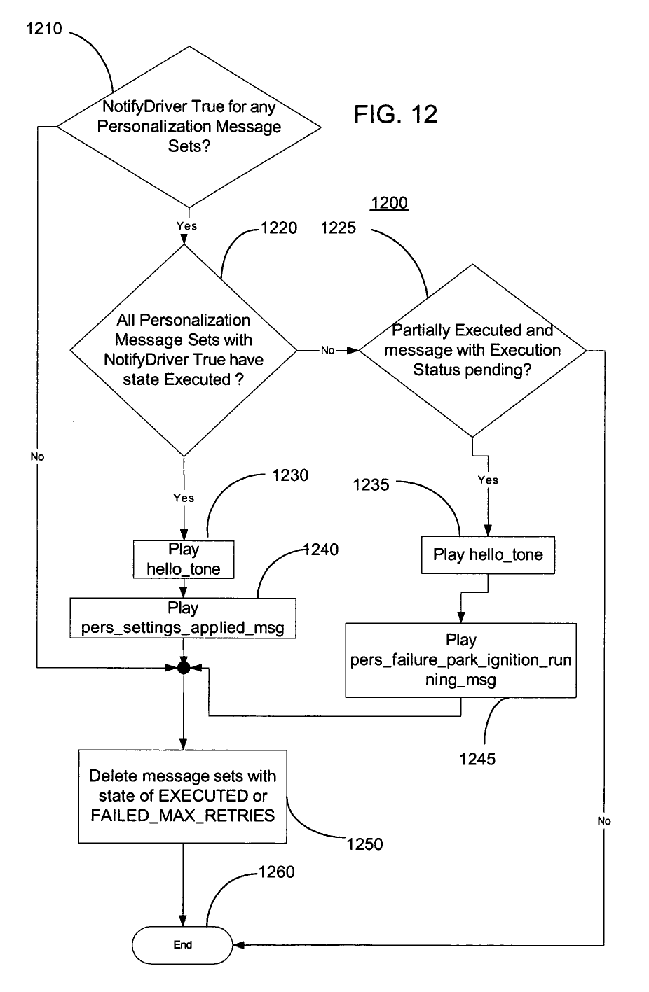

FIG. 12 illustrates one embodiment of a method 1200 for personalization message set post-processing, in accordance with one aspect of the invention. In one embodiment, method 1200 is performed during step 740.

Method 1200 begins at 1210 by determining if the driver is to be notified regarding the execution of any personalization message set. If the driver is not to be notified, method 1200 proceeds to delete all executed and/or failed personalization message sets at step 1250, and end at step 1260.

If the driver is to be notified, as determined in step 1210, method 1200 determines if all personalization message sets that are to notify the driver are executed at step 1220, and if so, a “hello tone” (hello_tone) is played at step 1230, a personal settings applied message (pers_settings_applied_msg) is played at step 1240, and flow proceeds to step 1250. If the step 1220 determination is negative, method 1200 determines whether a personalization message set is partially executed or the execution status is pending at step 1225, prior to playing a hello tone at step 1235 and playing a failure message at step 1245 before proceeding to step 1250.

The present invention may be embodied in other specific forms without departing from the spirit or essential characteristics. The described embodiments are to be considered in all respects only as illustrative and not restrictive. Those of ordinary skill in the art will readily recognize that specific time intervals or time spans other than those that are mentioned herein are contemplated, and would be able to implement such an alternate implementation without undue experimentation.

What is claimed is:

1. A method of customizing vehicle services, the method comprising:
receiving at least one telecommunication profile parameter at a telematics unit;
indexing the received telecommunication profile parameters to a user identification;
receiving a user identification signal; and
customizing at least one vehicle service based on the telecommunication profile parameters corresponding to the user identification signal.

2. The method of claim 1 further comprising storing the indexed information at a call center.

3. The method of claim 2 further comprising:
determining a new user identification signal; and
requesting an indexed telecommunication profile corresponding to the new user identification signal.

4. The method of claim 3 wherein requesting an indexed telecommunication profile comprises:
initiating a connection with a profile storage device in wireless communication with the telematics unit;
requesting the indexed telecommunication profile from the profile storage device via a wireless connection; and
receiving the indexed telecommunication profile from the profile storage device via a wireless connection.

5. The method of claim 4 wherein the profile storage device is located at a call center.

6. The method of claim 4 wherein the profile storage device is selected from the group consisting of a key fob, a lap top computer, a personal digital assistant, a cellular telephone, a MP3 player, a second vehicle, and a RFID tag.

7. The method of claim 1 wherein the telecommunications profile comprises information selected from the group consisting of phone numbers, points of interest, radio presets, navigational information, hotel preferences, restaurant preferences, website location information, email address, text messaging addresses, voice recognition information, identification information linked to at least one address, wake up cycle information, menu item preferences, reminder prompts, security mode, speech recognition learned profiles, speech recognition adapted acoustic models, personal reminders, twilight delay, auto exit seat, steering wheel control keys, speed controlled volume, oil life, radio theft reset, stealth mode for law enforcement fleets, and HVAC after blow settings.

8. A computer usable medium comprising computer readable code for customizing vehicle services, the medium comprising:
computer readable code for receiving at least one telecommunication profile parameter at a telematics unit;
computer readable code for indexing the received telecommunication profile parameters to a user identification;
computer readable code for receiving a user identification signal; and
computer readable code for customizing at least one vehicle service based on the telecommunication profile parameters corresponding to the user identification signal.

9. The medium of claim 8 further comprising computer readable code for storing the indexed information at a call center.

10. The medium of claim 9 further comprising:
computer readable code for determining a new user identification signal; and
computer readable code for requesting an indexed telecommunication profile corresponding to the new user identification signal.

11. The medium of claim 10 wherein computer readable code for requesting an indexed telecommunication profile comprises:
computer readable code for initiating a connection with a profile storage device in wireless communication with the telematics unit;
computer readable code for requesting the indexed telecommunication profile from the profile storage device via a wireless connection; and
computer readable code for receiving the indexed telecommunication profile from the profile storage device via a wireless connection.

12. The medium of claim 11 wherein the profile storage device is located at a call center.

13. The medium of claim 11 wherein the profile storage device is selected from the group consisting of a key fob, a lap top computer, a personal digital assistant, a cellular telephone, another vehicle, a MP3 player, and a RFID tag.

14. The medium of claim 8 wherein the telecommunications profile comprises information selected from the group consisting of phone numbers, points of interest, radio presets, navigational information, hotel preferences, restaurant preferences, website location information, email address, text messaging addresses, voice recognition information, identification information linked to at least one address, wake up cycle information, menu item preferences, reminder prompts, security mode, speech recognition learned profiles, speech recognition adapted acoustic models, personal reminders, twilight delay, auto exit seat, steering wheel control keys, speed controlled volume, oil life, radio theft reset, stealth mode for law enforcement fleets, and HVAC after blow settings.

15. A system for customizing vehicle services, the system comprising:
means for receiving at least one telecommunication profile parameter at a telematics unit;
means for indexing the received telecommunication profile parameters to a user identification;
means for receiving a user identification signal; and
means for customizing at least one vehicle service based on the telecommunication profile parameters corresponding to the user identification signal.

16. The system of claim 15 further comprising means for storing the indexed information at a call center.

17. The system of claim 16 further comprising:
means for determining a new user identification signal; and
computer readable code for requesting an indexed telecommunication profile corresponding to the new user identification signal.

18. The system of claim 15 wherein means for requesting an indexed telecommunication profile comprises:
means for initiating a connection with a profile storage device in wireless communication with the telematics unit;
means for requesting the indexed telecommunication profile from the profile storage device via a wireless connection; and
means for receiving the indexed telecommunication profile from the profile storage device via a wireless connection.
